(19) United States
(12) Patent Application Publication
(10) Pub. No.: US 2010/0092700 A1
(43) Pub. Date: Apr. 15, 2010

(54) HEAVY METAL-FREE LASER MARKING PIGMENT

(76) Inventors: James CARROLL, Cortlandt Manor, NY (US); Steven Alan JONES, Budd Lake, NJ (US); William LOUCKA, Avon, OH (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 12/251,591

(22) Filed: Oct. 15, 2008

(51) Int. Cl. B05D 3/06; C04B 14/34

(52) U.S. Cl. 427/597; 106/401; 106/479

(57) ABSTRACT

The invention provides a laser marking additive comprising mixed oxides of tin and a transition metal. Methods of making and using the additive are also provided.

### BACKGROUND OF THE INVENTION

The labeling of products is becoming of increasing importance in virtually all sectors of industry. For example, production dates, use-by dates, bar codes, company logos, serial numbers, etc., must frequently be applied. At present, these marks are predominantly made using conventional techniques such as printing, embossing, stamping, and labeling. However, the importance of non-contact, very rapid and flexible marking using lasers, in particular in the case of plastics, is increasing. This technique makes it possible to apply graphic inscriptions, for example bar codes, at high speed even on a non-planar surface. Since the inscription is in the plastic article itself, it is durable and abrasion-resistant.

The desirability of marking articles through the use of a laser system is well known. Lasers have been developed so that the beam impinged on the article to be marked can be highly focused to provide fine lines in the form of letters and/or numbers of the desired size, as well as images. Lasers permit the marking to be on the surface of the article or beneath the surface. In many instances, it is desirable to have the mark disposed subsurface in order to make it more difficult to remove the indication. Such a subsurface mark, can for example, contribute to anti-counterfeiting efforts. Laser marking, whether surface or subsurface, can also be used, for example, for electronically scanning and control purposes during production.

Laser marking is a fast and economical way of producing permanent marks on plastic articles during manufacture. Laser marking offers several advantages over conventional methods. The marks are highly scratch-resistant. The marking process imposes a lower environmental impact. Laser marking is highly versatile. The marking may be implemented at the end of production lines of plastic articles and does not require pretreating the surface.

A number of laser beam processes in which an identification mark is burned into the surface of an article part are known. The resulting rough surface usually has to be coated with a transparent lacquer on account of the danger of contamination and the unpleasant feel that results. This can become a very involved operation in the case of mass produced parts and adds to the cost of the product.

The use of laser beam marking systems for creating subsurface marks is also known. Such systems are based on creating the mark by having the article to be marked be composed of a special configuration of materials or incorporating a material within the article which either becomes visible when exposed to the laser beam or causes something else present to become visible. For example, U.S. Pat. No. 4,822,973 discloses a system in which the laser beam passes through the surface of a first plastic material in order to be absorbed in a layer of a second plastic material. This system requires a special configuration of materials of construction in the part to be marked.

Other systems incorporate a quantity of carbon black, coated mica or a highly absorbing green pigment, all of which absorb energy from the laser beam to produce a visible mark. However, these materials have a degree of color which is sufficient to be visible prior to application of the laser beam and that can be unsightly or interfere with the distinctness of the mark after the laser beam has been applied. This disadvantaging characteristic is aggravated by the fact that these additives tend to require a high loading content into the article to be marked, which is not only undesirable because of the effect on appearance, but also can effect the physical and mechanical properties of the object. Further, absorbance of the laser beam to cause local heating also causes a degree of foaming which detracts from the creation of a fine and distinct mark, resulting in a blemished product. Moreover, the additives tend to be specific to the wavelength emitted by the laser. For example, materials initially developed for use in conjunction with carbon dioxide lasers tend not to work particularly well (or even at all) with the increasingly popular yttrium aluminum garnet (YAG) lasers, which require a material which absorbs at 1064 nm.

Laser marking additives render polymers laser markable by acting as a light absorber for the laser light. Materials that act in this capacity often absorb visible light as well, which imparts a color to the piece to be marked. The color can be in contrast to the desired color of the piece, or it may dilute the desired color. The additive may also reduce clarity of a transparent piece. An appearance change can also be due to scattering of light by the additive. This can happen whether the additive has color or not. As a result, laser marking additives must be used in low concentrations, and/or not used in transparent applications.

In commonly assigned, U.S. Pat. No. 6,693,657, issued Feb. 17, 2004, a novel YAG laser marking additive (MARK-IT™), and its use, are described The YAG laser marking additive is a calcined powder of co-precipitated mixed oxides of tin and antimony. When the powder absorbs YAG laser energy and converts it into heat, carbonization of the surrounding material occurs and results in the formation of a black or dark mark that contrasts to the remainder of the surrounding area. Because of the particle size of the powder and its efficiency, the powder does not impart an appreciable amount of color to the object in which it is incorporated. It also does not cause excess foaming so that the mark achieved is smoother in texture.

In commonly assigned U.S. Pat. No. 7,187,396, issued Mar. 6, 2007, a YAG laser marking additive comprising particles of mixed oxides of tin and antimony wherein the particles are less than 100 nm, and its use, are described. The reduced particle size results in the reduction of the scattering power of the additive, while retaining absorptivity of the laser light.

It is therefore the object of this invention to provide a YAG laser marking additive that does not contain antimony or other heavy metals and which will produce a black or dark mark contrasting with the surrounding area when exposed to YAG laser energy.

### SUMMARY OF THE INVENTION

This invention relates to a laser marking additive and its use. The laser marking additive is particularly useful as a YAG laser marking additive. More particularly, the laser marking additive of the present invention is a calcined powder of mixed oxides of tin and a transition metal selected from the group consisting of tungsten, niobium, vanadium and chromium. In certain embodiments, the additive does not comprise antimony or other heavy metals. When the powder absorbs YAG laser energy and converts it into heat, carbonization of the surrounding material occurs and results in the formation of a black or dark mark that contrasts to the remainder of the surrounding area. Advantageously, the powder does not impart an appreciable amount of color to the object in which it is incorporated. The laser marking additives are particularly useful in processes for marking plastic articles, including transparent plastic components, as well as for marking applied polymeric coatings or inks. Polymers incorporating the additive material of this invention laser mark readily with lasers.

### DESCRIPTION OF THE INVENTION

In accordance with the present invention, provided is a laser marking additive that is adapted for use in conjunction with a YAG laser. The additive is a calcined powder of mixed oxides of tin and a transition metal selected from the group consisting of tungsten, niobium, vanadium and chromium. In an embodiment, niobium is a transition metal. The powder is principally tin oxide and only a small amount of transition metal oxide. When the transition metal is niobium, the level of niobium oxide Nb₂O₅, can be up to about 10% (w/w) In some embodiments, the level of niobium oxide Nb₂O₅ is from about 1% to about 5%. Further, in some embodiments, the level of niobium oxide Nb₂O₅ is from about 1% to about 2.5%. When the transition metal is tungsten, the level of tungsten oxide WO₃, can be up to about 20% (w/w). In some embodiments, the level of WO₃ is from about 8% to about 20%. When the transition metal is vanadium, the level of vanadium oxide V₂O₅ may range from about 1.5% to about 7.0% (wlw). In some embodiments, the level of vanadium oxide is between from about 3.5% to about 6.0%. When the transition metal is chromium, the level of chromium oxide Cr₂O₃, may be from about 0.1% to about 1.5% (w/v). In some embodiments, the level of chromium oxide it is between from about 0.3% to about 1.2%.

In some embodiments, the laser marking additive excludes molybdenum, bismuth, antimony and other heavy metals. Heavy metals include, but are not limited to, copper, zinc, nickel, lead, cadmium, cobalt, mercury, manganese, silver, gold, platinum, palladium, arsenic, indium, rhodium, ruthenium, technetium, osmium, iridium, uranium, plutionium, lanthanides, and actinides, and mixtures thereof. In some embodiments, the laser marking additive excludes platy substrates, such as glass flakes and mica. In other embodiments, the laser marking additive consists essentially of mixed oxides of tin and a transition metal selected from the group consisting of tungsten, niobium, vanadium and chromium.

The mixed oxides of the invention may be prepared by any method known in the art. In some embodiments, tin oxide and the transition metal oxide are combined and mixed thoroughly, for instance using a Waring blender or appropriate mixing device for large scale production. The mixed oxide powder is then calcined at an appropriate temperature, for example, at least about 1000° C. and in some embodiments, at least about 1250° C., and which usually does not exceed about 1350° C. The calcination time is usually at least about 0.5 hour. In some embodiments, the calcination time may be at least about 3.0 hours, but usually less than about 5.0 hours. In some instances, calcination (e.g., temperature too low or too high, duration too short or too long) may adversely impact the calcined product's laser marking properties. In some embodiments, color development is minimized in the calcined product. In these embodiments, calcination may be performed at lower temperatures and/or for shorter periods of time. In other embodiments, laser marking properties are more important than color development in the calcined product. In these embodiments, calcination may be performed at higher temperatures and/or for longer periods of time. Calcination conditions are readily adjusted by the skilled artisan without undue experimentation to yield a pigment suitable for laser marking in accordance with the invention.

The mixed oxides of the invention may also be prepared by co-precipitation. Any procedure which causes the co-precipitate to form preferably at low pH can be employed for preparing the laser marking additive of the invention. One procedure which can be used involves forming a solution from salts or oxides of tin and a transition metal and then adjusting the conditions so as to cause the oxides to co-precipitate. In this method, the identity of the oxide or salt is not critical and any material can be selected as long as both the tin and transition metal reagents can be dissolved in the same solvent. For example, aqueous acidic solutions can be prepared using the oxides, sulfates, fluorides, chlorides, bromides and iodides of the metals, as well as salts of organic acids which are soluble. These materials may be dissolved in water, with the assistance of a mineral acid if needed or helpful. The mixed oxides can be made to precipitate from such a solution by changing the pH to an appropriate level. Any convenient base can be used to adjust the pH. In some embodiments, sodium hydroxide is used because of its ready availability. In some embodiments, the pH during precipitation is low and by that is meant the pH is less than about 2.6, and in some cases between about 1.6 to 2.1. The resulting precipitate can be recovered from the solution by any convenient means such as filtering or centrifuging and, if desired, washed. The resulting precipitate is thereafter calcined as described above.

The resulting calcined material is usually a particulate but can, and usually is, thereafter ground or milled to a desired size. It is desirable that the particles have an average size in the range of about 10 nanometers (nm) to about 10 micrometer (μm), and in some embodiments, about 25 nm to about 5 microns. In some embodiments, the particles have an average size in the range of about 50 nm to about 1 micron, as measured by light scattering. Various and known methods are available for forming the laser marking additives into nano-sized particles (less than about 100 nm). Particles having an average size of less than about 100 nm are also preferred. In some embodiments, the average particle size is from about 25 nm to about 50 nm. Techniques for producing nano-sized materials generally fall into one of three categories, namely, mechanical processing, chemical processing, or physical (thermal) processing. In mechanical processes, fine powders are commonly made from large particles using crushing techniques such as a high-speed ball mill. With chemical processes, nano materials are created from a reaction that precipitates particles of varying sizes and shapes using a family of materials known as organometallics (substances containing combinations of carbon and metals bonded together) or various metal salts. The chemical processes are often combined with thermal processing, e.g. pyrolysis.

Chemical processing can take place in the gas or liquid phase. Gas phase syntheses include metal vapor condensation and oxidation, sputtering, laser-ablation, plasma-assisted chemical vapor deposition, and laser-induced chemical vapor deposition. Liquid phase processing encompasses precipitation techniques, and sol-gel processing. Aerosol techniques include spray drying, spray pyrolysis, and flame oxidation/hydrolysis of halides.

Of the aerosol processing techniques available for production of ceramic powders, spray pyrolysis and flame oxidation of halides are the primary methods used to produce ultrafine powders. In both methods, submicron sized droplets of solutions of metal salts or alkoxides can be produced by standard aerosolization techniques. In spray pyrolysis, the resulting aerosol is thermolyzed, to pyrolytically convert the aerosol droplet to an individual ceramic particle of the same stoichiometry as the parent solution. Thermal events in the process include solvent evaporation, solute precipitation, thermal conversion of the precipitate to a ceramic, and sintering of the particle to full density.

Spray pyrolysis is most commonly used for the preparation of metallic ceramic powders. The resultant powders typically have sizes in the 100 to 10,000 nm range. The particle sizes produced are controlled by the size of droplets within the aerosol and the weight percent dissolved solids in the solution. The final particle size decreases with smaller initial droplet sizes and lower concentrations of dissolved solids in solution.

Aerosolization may be accomplished by several well known technologies. For example, a precursor solution may be atomized by flow through a restrictive nozzle at high pressure, or by flow into a high volume, low pressure gas stream. When such atomizers are used, the high volume gas stream should be air, air enriched with oxygen, or substantially pure oxygen. In an embodiment, the atomizers use a high volume of substantially pure oxygen. When high pressure atomization through a restrictive orifice is used, the orifice is preferably surrounded by jets of one of the above gases, preferably oxygen. More than one atomizer for aerosolization may be positioned within the flame pyrolysis chamber. Other aerosol-producing methods, for example ultrasonic or piezoelectric droplet formation, may be used. However, some of these techniques may undesirably affect production rate. Ultrasonic generation is preferred, the aerosol generator generating ultrasound through reasonant action of the oxygen flow and the liquid in a chamber.

The aerosol is ignited by suitable means, for example laser energy, glow wire, electrical discharge, but is preferably ignited by means of an oxyhydrogen or hydrocarbon gas/oxygen torch. Prior to initiating combustion, the flame pyrolysis chamber is preheated to the desired operating range of 5000° C. to 2000° C. In some embodiments the pyrolysis chamber is preheated to a range of 700° C. to 1500° C. In some embodiments, the pyrolysis chamber is preheated to a range of 800° C. to 1200° C. Preheating improves particle size distribution and minimizes water condensation in the system. Preheating may be accomplished through the use of the ignition torch alone, by feeding and combusting pure solvent, i.e. ethanol, through the atomizer, by resistance heating or containment in a muffle furnace, combinations of these methods, or other means. U.S. Pat. No. 7,187,396, incorporated herein in its entirety, discloses numerous examples how to form nano-sized particles. These methods include those disclosed in U.S. Pat. Nos. 5,128,081; 5,486,675; 5,711,783; 5,876,386; 5,958,361; 6,132,653; 6,600,127; 5,788,738; 5,851,507; 5,984,997; and 6,569,397.

In some embodiments, the additives of the invention may comprise other components. Exemplary components include, but are not limited to, carbon black, graphite, zirconium silicates, calcium silicates, zeolite, cordierite, mica, kaolin, talc, silica, aluminum silicates, metal salts such as copper phosphates, and the like. Any commercially available organic pigment or inorganic pigment is suitable for use as a colorant. Exemplary organic pigments include, but are not limited to, Barium red 1050® (Cook Son), Filamid yellow®, Filamid red GA®, Heliogen green K8730®, Heliogen blue K6911D, LISA red 57Y® LISA red 61R (Bayer), 1290 Rightfit™ Yellow, 2920 Rightfit™ Brilliant Orange, 1112 Rightfit™ Scarlet (Engelhard), and the like.

The heavy metal-free SnO₂ compositions of the invention are highly efficient as a YAG laser marking additive. That efficiency permits only a small quantity of the powder to be added to the material to be marked and still achieve the desired marking attributes. In general, the marking additive loading is about 0.01% to about 5% of the total weight of the article to be marked. In some embodiments, the marking additive loading is about 0.01 % to about 0.5%. Further, in some embodiments, the marking additive loading is about 0.025% to about 0.1%. Additive levels of at least 0.025 wt % are particularly useful. The laser marking additive can be incorporated into any plastic material which is transparent to YAG laser irradiation by any convenient method. Accordingly, the invention further provides a method of preparing a laser markable plastic and a method of preparing a laser marked article.

When the additive of the invention is nano-sized, dispersing the additive within the plastic may be problematic. The small particle size of the marking additive may result in agglomeration of the additive and a less than uniform dispersion or mixing of the additive within the plastic composition and ultimate object that is formed. Accordingly, surface treatment of the laser-marking additives to reduce agglomeration may be useful. Such surface treatments are known in the art and include, for example, silanes, fatty acids, low molecular weight polymeric waxes, titanates, etc. Functionalized silanes may be particularly useful as the functionality can also render the additive compatible with the plastic to enhance uniform mixing within the plastic an avoidance of additive segregation. Typically the additive in powder form, whether treated or untreated, is mixed with the. plastic prior to molding or applied as a coating. The plastic for molding can be in the form of chips, powders, or pellets. The solid mixture is then melted and mixed such as in an injection molding process, blow molding, or extrusion molding and the like. Alternatively, the laser marking additive may be thoroughly mixed with the melted resin and molded into chips, powders, or pellets which are again melted just prior to molding.

In the laser marking methods of the invention, any laser that has readily adjustable variable parameters that govern laser energy characteristics, such as pulse content, pulse duration and pulse frequency, may be employed. Preferably, the laser has a wavelength in the near infrared (780 nm to 2000 nm). Suitable lasers include, but are not limited to, solid state pulsed lasers and continuous wave lasers with pulse modification, such as the commercially available Nd:YAG laser (wavelength 1064 nm), frequency-doubled Nd:YAG laser (wavelength 532 nm), and diode laser at about wavelength 1064 nm. In some embodiments, the laser is a Nd:YAG laser (wavelength 1064 nm) or a diode laser (at about wavelength 1064 nm). In other embodiments, the laser is a single mode YAG laser (wavelength 1064 nm). In some embodiments, a single mode YAG laser is preferred for laser marking using chrome-doped tin oxide or vanadium-doped tin oxide in accordance with the invention.

The material to be marked can be an organic object such as a plastic or polymeric article. Typical polymers include, but are not limited to, polyolefins such as polyethylene, polypropylene, polybutadiene and the like; (meth)acrylic polymers such as polyethyl acrylate and polymethyl methacrylate and the like; polyesters such as polyethylene terephthalate and polybutylene terephthalate and the like; polyvinyl chloride; polyvinylidene chloride; polyacrylonitrile; epoxy resins; and polyurethanes. The polymer can also be a copolymer or block copolymer, etc. Conventional additives may be present. The material of which the object is composed is limited only by the necessity of being transparent to YAG laser irradiation.

Plastic articles suitable for laser marking include any plastic articles that are molded, extruded or formed by any known conventional method. No limits regarding the shape of the article to be marked can be contemplated. Three-dimensional plastic parts, containers, packages, etc., regardless of how formed such as by injection molding, extrusion, blow molding, and the like can include the additives of this invention and marked by a laser by techniques known in the art. The plastic articles comprise resins and laser energy absorbing additives and may further comprise other additives, provided the additives do not interfere with the laser marking of the articles. Such other additives are known to those skilled in the art of polymer compounding and include, but are not limited to, reinforcing fillers, flame retardants, antioxidants, dispersants, impact modifiers, ultraviolet stabilizers, plasticizers, and the like. The laser energy absorbing additives of this invention may also be incorporated into plastic coatings, including coatings or inks formed from aqueous or non-aqueous solutions or dispersions of polymeric materials or powdery polymeric coatings. Such coatings or inks can be applied onto the surface of any article such as those formed of plastic, metal, glass, ceramic, wood, etc. Thus, the plastic coatings containing the laser marking additives of this invention allow the use of lasers to mark any type of substrate.

Besides three-dimensional parts, containers, packages, and the like, the additives, for example, can be incorporated into plastic sheeting or film to produce transparent (or color-free) plastic sheeting that can be laser marked with a dark mark. Potential applications include packaging, labeling, and laminated plastic sheets. The additives can be incorporated into co-extruded multilayered films such as iridescent film to produce special effect film that can be laser marked. One marking option is to produce a dark mark similar to above, and the other option is to use low power laser to heat the film to melting, rather than charring, to produce a mark with different optical properties from the original iridescent film. Potential applications include packaging, labeling, and laminated plastic sheets. The additives can be incorporated into plastic that is blown to make transparent (or color-free) plastic bags that can be laser marked with a dark mark. Potential application is the ability to mark a plastic bag for any purpose including labeling with information on the contents of the bag.

A kit useful for laser marking a plastic article is also provided by the invention. The kit comprises a laser marking additive of the invention and instructional material. “Instructional material,” as that term is used herein, includes a publication, a recording, a diagram, or any other medium of expression which can be used to communicate the usefulness of the laser marking additive of the invention for its designated use. The instructional material of the kit may, for example, be affixed to a container that contains the additive or be shipped together with a container which contains the compound and/or composition. Alternatively, the instructional material may be shipped separately from the container with the intention that the recipient uses the instructional material and the additive cooperatively. Delivery of the instructional material may be, for example, by physical delivery of the publication or other medium of expression communicating the usefulness of the kit, or may alternatively be achieved by electronic transmission, for example by means of a computer, such as by electronic mail, or download from a website. In an embodiment, the additive comprises a calcined powder of mixed oxides of tin and niobium.

### EXAMPLES

In order to further illustrate the present invention, various examples are given below. Throughout these examples, as well as throughout the rest of this specification and claims, all parts and percentages are by weight and all temperatures are in degrees Centigrade unless indicated otherwise.

Sample Preparation

### Example 1

Two different compositions of niobium-doped tin oxide were prepared using the quantities indicated in Table 1. Inv. 1 contained about 5.3% Nb₂O₅ and Inv. 2 contained about 10.7% Nb₂O₅.

TABLE 1

| | Inv. 1 | Inv. 2 |
|---|---|---|
| SnO₂ | 142 grams | 134 grams |
| Nb₂O₅ | 8 grams | 16 grams |

The components for each inventive sample were combined and blended in a Waring blender. The samples were then calcined in a gas kiln to 1250° C. with a 5 hour ramp and a 3 hour hold. Each calcined sample was removed from the sagger and mixed to achieve a uniform pigment. Both Inv. 1 and Inv. 2 were a light gray calcine.

### Example 2

Two different compositions of niobium-doped tin oxide were prepared using the quantities indicated in Table 2. Inv. 3 contained about 1.2% Nb₂O₅ and Inv. 4 contained about 1.3% Nb₂O₅.

TABLE 2

| | Inv. 3 | Inv. 4 |
|---|---|---|
| SnO₂ hydrate (SnO₂ × H₂0) | 54.82 grams | — |
| SnO₂ (TEGO VS) | — | 49.34 grams |
| Nb₂O₅ | 0.66 grams | 0.66 grams |

The components for each inventive sample were combined and blended in a Waring blender. The samples were then calcined in a gas kiln to 1250° C. with a 5 hour ramp and a 3 hour hold. Each calcined sample was removed from the sagger and mixed to achieve a uniform pigment. Inv. 3 was a medium gray calcine. Inv. 3 was a light gray calcine.

### Example 3

Two different compositions of niobium-doped tin oxide were prepared using the quantities indicated in Table 3. Inv. 5 contained about 1.2% Nb₂O₅and Inv. 6 contained about 2.4% Nb₂O₅.

TABLE 3

| | Inv. 5 | Inv. 6 |
|---|---|---|
| SnO₂ hydrate (SnO₂ × H₂0) | 54.82 grams | 54.07 grams |
| Nb₂O₅ | 0.66 grams | 1.33 grams |

The components for each inventive sample were combined and blended in a Waring blender. The samples were then calcined in a gas kiln to 1000° C. with a 5 hour ramp and a 3 hour hold. Each calcined sample was removed from the sagger and mixed to achieve a uniform pigment. Both Inv. 5 and Inv. 6 were an off-white calcine.

### Example 4

Two different compositions of tungsten-doped tin oxide were prepared using the quantities indicated in Table 4. Inv. 7 contained about 9.3% WO₃. Inv. 8 contained about 18.7% WO₃.

TABLE 4

| | Inv. 7 | Inv. 8 |
|---|---|---|
| SnO₂ | 136.0 grams | 122.0 grams |
| WO₃ | 14.0 grams | 28.0 grams |

The components for each inventive sample were combined and blended in a Waring blender. The samples were then calcined in a gas kiln to 1250° C. with a 5 hour ramp and a 3 hour hold. Each calcined sample was removed from the sagger and mixed to achieve a uniform pigment. Inv. 7 was a light blue gray sintered calcine. Inv. 8 was an off-white sintered calcine.

### Example 5

A composition of chrome-doped tin oxide was prepared using the materials and quantities indicated in Table 5. The resulting composition contained about 0.3% Cr₂O₃.

TABLE 5

| | Inv. 9 |
|---|---|
| SnO₂ | 40.5 grams |
| Silica | 23.9 grams |
| Calcium carbonate (CaCO₃) | 35.3 grams |
| Chrome oxide (Cr₂O₃) | 14.0 grams |

The components for the inventive composition were ballmilled with water for 10 hours and then dried. The samples were then calcined in a gas kiln to 1300° C. with a 5 hour ramp and a 3 hour hold. The calcined material was ballmilled with water for 3 hours. The material was dried and pulverized.

### Example 6

A vanadium-doped tin oxide composition was prepared using the quantities indicated in Table 3. The resulting composition contained about 5.8% V₂O₅.

TABLE 6

| | Inv. 10 |
|---|---|
| SnO₂ | 94.2 grams |
| Vanadium pentoxide (V₂O₅) | 5.8 grams |

The components for the inventive sample were combined and blended in a Waring blender. The sample was then calcined in a gas kiln to 1325° C. with a 5 hour ramp and a 3 hour hold. The calcined sample was ballmilled with caustic soda (to remove excess vanadium pentoxide) and then washed to remove the soda. The washed sample was dried and pulverized.

Laser Marking

Laser marking of inventive examples 1 and 2 were tested at three different concentrations (0.05, 0.1 and 0.2%). An appropriate charge of each inventive sample plus 0.2% titanium oxide (TiO₂) was added to HDPE and dispersed therein. A multimode YAG laser beam was used for testing laser marking. Both inventive samples 1 and 2 marked well at all concentrations tested.

Inventive examples 3-8 were also tested at three different concentrations (0.05, 0.1 and 0.2% (w/w)). Marking was conducted using a standard multimode YAG laser with varying pulse energy (ranging from about 10 to about 80 Amps) and frequency (ranging from about 5 to about 20 kHz) and small squares of each sample. By the action of the laser on the sample, black, gray or off white marks were made.

| | % (w/v) | Laser mark result |
|---|---|---|
| Inv. 3 | 0.05% | Gray mark |
| | 0.1% | Gray mark |
| | 0.2% | Gray mark |
| Inv. 4 | 0.05% | Marked somewhat |
| | 0.1% | Marked somewhat |
| | 0.2% | Marked somewhat |
| Inv. 5 | 0.05% | No mark |
| | 0.1% | No mark |
| | 0.2% | No mark |
| Inv. 6 | 0.05% | No mark |
| | 0.1% | No mark |
| | 0.2% | No mark |

The data for Inv. 1-6 indicate that niobium-doped tin oxide is useful as a laser marking pigment. It is noted that Inv. 5 and 6, calcined at a lower temperature compared to Inv. 1-4, did not mark with the multimode laser YAG. It is expected that these samples would mark if a single mode laser were used, as single mode lasers have more power. These data suggest that niobium-doped tin oxide needs to be calcined under conditions that yield a pigment suitable for laser marking.

| | | |
|---|---|---|
| Inv. 7 | 0.05% | No mark |
| | 0.1% | No mark |
| | 0.2% | No mark |
| Inv. 8 | 0.05% | Marked poorly |
| | 0.1% | Marked poorly |
| | 0.2% | Marked fairly well |

The data for Inv. 7 and 8 indicate that at concentrations greater than about 9.3%, tungsten-doped tin oxide is useful as a laser marking pigment. It is contemplated that the Inv. 7 samples would mark if a single mode laser were used, as single mode lasers have more power. Inv. 8 did produce a slight darkening of the sample, due to the high load of the off-white pigment.

Inventive examples 9 and 10 were tested at four different concentrations as indicated. Marking was conducted using a standard multimode YAG laser with varying pulse energy (ranging from about 10 to about 80 Amps) and frequency (ranging from about 5 to about 20 kHz) and small squares of each sample, made to be black, gray or off white. Marking was also tested using a single mode YAG laser, which has more focused power and a higher peak power.

| | % (w/w) | Multimode YAG | Single mode laser |
|---|---|---|---|
| Inv. 9 | 0.025% | Marked faintly | Marked well |
| | 0.05% | Marked faintly | Marked well |
| | 0.1% | Marked faintly | Marked well |
| | 0.2% | Marked faintly | Marked well |
| Inv. 10 | 0.025% | Marked faintly | Marked well |
| | 0.05% | Marked faintly | Marked well |
| | 0.1% | Marked faintly | Marked well |
| | 0.2% | Marked faintly | Marked well |

These data show that both chrome-doped tin oxide (Inv. 9) and vanadium-doped tin oxide (Inv. 10) are useful for laser marking, particularly when a single mode YAG laser is utilized.

The disclosures of each and every patent, patent application, and publication cited herein are hereby incorporated herein by reference in their entirety.

While the invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A laser marking additive comprising a calcined powder of mixed oxides of tin (Sn) and a transition metal selected from the group consisting of: niobium (Nb), tungsten (W), vanadium (V) and chromium (Cr).

2. The additive of claim 1, wherein said transition metal is niobium.

3. The additive of claim 2, wherein said additive comprises about 1% to about 2% niobium oxide.

4. The additive of claim 1, wherein said additive excludes heavy metals.

5. The additive of claim 4, wherein said heavy metals are selected from the group consisting of bismuth, molybdenum and antimony.

6. The additive of claim 1, wherein said additive has a particle size of about 0.1 to about 10 micrometers (μM).

7. A laser marking additive consisting essentially of a calcined powder of mixed oxides of tin (Sn) and a transition metal selected from the group consisting of: niobium (Nb),, tungsten (W), vanadium (V), chromium (Cr) and mixtures thereof.

8. A method of making a laser marking additive, said method comprising:
combining tin oxide and a transition metal oxide to form a mixed oxides powder, wherein said transition metal is selected from the group consisting of: niobium (Nb), tungsten (W), vanadium (V) and chromium (Cr), and
calcining said mixed oxides powder,
thereby making said laser marking additive.

9. The method of claim 8, wherein said transition metal is niobium.

10. The method of claim 9, wherein said additive comprises about 1% to about 2% niobium oxide.

11. The method of claim 8, wherein said additive excludes heavy metals.

12. The method of claim 11, wherein said heavy metals are selected from the group consisting of bismuth, molybdenum and antimony.

13. The method of claim 8, wherein said additive consists essentially of a calcined powder of mixed oxides of tin (Sn) and a transition metal selected from the group consisting of: niobium (Nb), tungsten (W), vanadium (V) and chromium (Cr).

14. A method of laser marking an article, said method comprising contacting an article containing a laser marking additive with a laser beam, wherein said additive comprises a calcined powder of mixed oxides of tin (Sn) and a transition metal selected from the group consisting of: niobium (Nb), tungsten (W), vanadium (V) and chromium (Cr).

15. The method of claim 14, wherein said transition metal is niobium.

16. The method of claim 15, wherein said additive comprises about 1% to about 2% niobium oxide.

17. The method of 15, wherein said laser marking additive is present in said article at about 0.025% to about 0.5% (wlw).

18. The method of claim 14, wherein said additive excludes heavy metals.

19. The method of claim 18, wherein said heavy metals are selected from the group consisting of bismuth, molybdenum and antimony.

20. The method of claim 14, wherein said additive consists essentially of a calcined powder of mixed oxides of tin (Sn) and a transition metal selected from the group consisting of: niobium (Nb), tungsten (W), vanadium (V) and chromium (Cr).

21. The method of claim 14, wherein said laser is a YAG laser.

22. A laser markable article comprising a body of material which is transparent to a laser beam and which contains a laser marking additive comprising a calcined powder of mixed oxides of tin (Sn) and a transition metal selected from the group consisting of: niobium (Nb), tungsten (W), vanadium (V) and chromium (Cr).
